(19) United States
(12) Patent Application Publication
(10) Pub. No.: US 2025/0316963 A1
(43) Pub. Date: Oct. 9, 2025

(54) ELECTRICAL MODULES WITH REVERSIBLE CONNECTION ARRANGEMENT

(71) Applicant: Group Dekko, Inc., Fort Wayne, IN (US)

(72) Inventor: Brian K. Rupert, Kendallville, IN (US)

(73) Assignee: Group Dekko, Inc., Fort Wayne, IN (US)

(21) Appl. No.: 18/630,420

(22) Filed: Apr. 9, 2024

(51) Int. Cl. H02B 1/015; A47B 21/06

(52) U.S. Cl. CPC H02B 1/015; A47B 21/06; A47B 2021/066

(57) ABSTRACT

An electrified office furniture system includes: at least one piece of office furniture; and an electrical distribution system associated with the at least one piece of office furniture, the electrical distribution system including: a first electrical module; and a second electrical module, the first electrical module and the second electrical module being selectively and releasably connected directly to one another in one of two orientations, and being configured for being selectively and releasably connected directly to one another in the other of the two orientations.

### BACKGROUND OF THE INVENTION

### 1. Field of the Invention

The present invention relates to electrified furniture systems, and, more particularly, to electrical modules of the electrified furniture systems.

### 2. Description of the Related Art

Furniture includes office furniture, such as wall panels (such as modular wall panels), tables, benches, desks, shelves, or the like. At least certain types of office furniture can be associated with electrical distribution systems, so as to carry electricity to desired locations.

Modular wall panels have been used for a number of years to divide a relatively large open space into smaller cubicles or workspaces and have the advantage of being comparatively easily rearranged. Electrification of those wall panels was one of the early improvements. Many techniques for power or communications wiring in modular furniture are known. Wall panels and other modular components may have raceways for enclosing the wiring which may be installed on site as the panels are being assembled, or which may be factory installed to be later interconnected by panel-to-panel interconnects or jumpers. The electrification of such wall panels may thus be accomplished by an electrical distribution system.

Generally, such an electrical distribution system may include multiple channel electrical distribution harnesses (which can also be referred to as an electrical distribution harness assembly or an electrical distribution harness), electrical cables, e.g. jumper cables (which can also be referred to as jumper devices, jumper assemblies, or jumpers), which interconnect the electrical distribution harnesses together, and electrical receptacles. Each electrical distribution harness may mount multiple inlet connection points for receiving the jumpers and electrical receptacle connection points for receiving the electrical receptacles. Each electrical distribution harness may distribute electrical power from the jumpers to the electrical receptacles. The electrical distribution system is typically mounted internally within a structure, such as a wall (such as the aforementioned modular wall panels) or a series of desks.

The wall panels, for instance, that accommodate the electrical distribution system must be wide enough to accommodate the electrical distribution system. The width of such wall panels are already minimized. Thus, a problem arises when a thinner wall panel is desired, such as a one-inch thick wall panel.

What is needed in the art is an improved electrical distribution system which can be accommodated at least substantially within thin wall panels.

### SUMMARY OF THE INVENTION

The present invention provides an electrical distribution system that includes first and second electrical modules that can be selectively connected to one another in either of two orientations.

The invention in one form is directed to an electrified office furniture system includes: at least one piece of office furniture; and an electrical distribution system associated with the at least one piece of office furniture, the electrical distribution system including: a first electrical module; and a second electrical module, the first electrical module and the second electrical module being selectively and releasably connected directly to one another in one of two orientations, and being configured for being selectively and releasably connected directly to one another in the other of the two orientations.

The invention in another form is directed to an electrical distribution system for an electrified office furniture system, the electrified office furniture system including at least one piece of office furniture, the electrical distribution system being associated with the at least one piece of office furniture, the electrical distribution system including: a first electrical module which is configured for being selectively and releasably connected directly with a second electrical module in one of two orientations and for being selectively and releasably connected directly with the second electrical module in the other of the two orientations.

The invention in yet another form is directed to a method of using an electrified office furniture system, the method including the steps of: providing that the electrified office furniture system includes an at least one piece of office furniture and an electrical distribution system which is associated with the at least one piece of office furniture; connecting, selectively and releasably, a first electrical module of the electrical distribution system and a second electrical module of the electrical distribution system directly to one another in one of two orientations; and connecting, selectively and releasably, the first electrical module and the second electrical module directly to one another in the other of the two orientations.

An advantage of the present invention is that it provides electrical modules, such as electrical receptacles, that can be connected directly to one another facing in the same direction or facing in opposite directions relative to one another.

An advantage of the present invention is that it provides an electrical distribution system that does not require an electrical distribution module (such as an electrical distribution harness or a splitter block) or any other spacer device (which has one or more electrical connectors) to which electrical receptacles and jumper assemblies are attached, though the electrical distribution system can optionally include such an electrical distribution module. As a result, the electrical distribution system can be used within a piece of office furniture that is relatively thin, such as one-inch thick.

Another advantage of the present invention is that it provides an electrical distribution system that can be accommodated at least substantially within thin pieces of office furniture, such as one-inch thick pieces of office furniture (for example and not limitation, a one-inch thick raceway of a modular wall panel).

Yet another advantage of the present invention is that it provides an electrified office furniture system which can include various types of pieces of office furniture, such as wall panels (such as modular wall panels), tables, benches, desks, shelves, or the like.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of an electrified office furniture system including at least one piece of office furniture and an electrical distribution system, according to an exemplary embodiment of the present invention;

FIG. 2 is a perspective view of the electrical distribution system of FIG. 1, according to an exemplary embodiment of the present invention;

FIG. 3 is an exploded perspective view of the electrical distribution system of FIG. 2, according to an exemplary embodiment of the present invention;

FIG. 4 is an exploded side view of the electrical distribution system of FIG. 2, according to an exemplary embodiment of the present invention;

FIG. 5 is an exploded perspective view of an electrical terminal of the electrical distribution system of FIG. 2, according to an exemplary embodiment of the present invention;

FIG. 6 is a perspective view of the electrical distribution system of FIG. 2, according to an exemplary embodiment of the present invention;

FIG. 7 shows interior side views of the electrical distribution system of FIG. 2, with portions broken away, according to an exemplary embodiment of the present invention;

FIG. 8 is a side view of the electrical distribution system in a second orientation, according to an exemplary embodiment of the present invention; and

FIG. 9 is a flow diagram showing a method of using the electrified office furniture system, in accordance with an exemplary embodiment of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

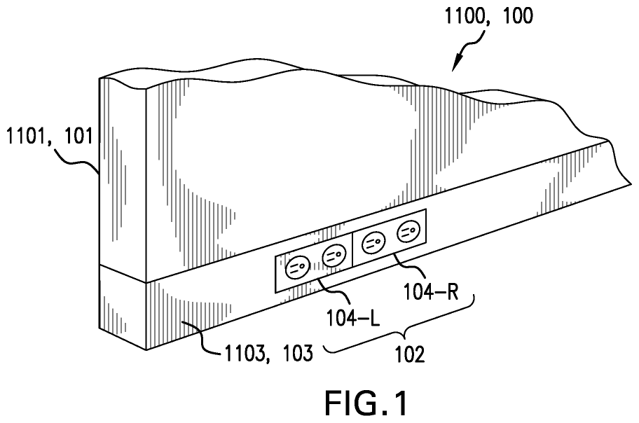

Referring now to the drawings, and more particular to FIG. 1, there is shown an electrified office furniture system 1100, which includes at least one piece of office furniture 1101 and an electrical distribution system 102 associated with the at least one piece of office furniture 1101. The reference number 1100 generally refers to an electrical distribution system of various embodiments, and the reference number 1101 generally refers to a piece of office furniture of various embodiments. Thus, office furniture 1101 generally refers to any sort of office furniture, which can be used to make a space suitable for working, though such office furniture 1101 need not be in an office but can be located in any location employing electricity. For example (and not limitation), office furniture 1101 can be, for example (and not limitation), wall panels (such as modular wall panels 101), tables, benches, desks, cabinets, shelves, raceways (though not part of a wall panel), or the like. Office furniture 1101, in FIG. 1, is shown according to one exemplary embodiment of the present invention to be a modular wall panel 101; thus, electrified office furniture system 1100, in FIG. 1, is shown according to one exemplary embodiment of the present invention to be an electrified wall panel system 100. Though electrified office furniture system 1100 is shown to be an electrified wall panel system 100 according to one embodiment of the present invention, electrified office furniture system 1100 is not limited to being an electrified wall panel system 100, as indicated by the notion that office furniture 1101 can be not only wall panel 101 but other types of office furniture 1101, as indicated above. Further, electrical distribution system 102 is associated with office furniture 1101 in any suitable manner. For instance, electrical distribution system 102 can be positioned on or in (in whole or in part) office furniture 1101 and can be coupled with office furniture 1101 in any suitable manner. For example, the at least one piece of office furniture 1101 can include an elongate distribution arrangement 1103 (the reference number 1103 generally refers to an elongate distribution arrangement of various embodiments), the electrical distribution system 102 being associated with elongate distribution arrangement 1103 and optionally being coupled with elongate distribution arrangement 1103. Thus, in the embodiment shown and described herein, office furniture 1101 is shown as modular wall panel 101, which can be a plurality of modular wall panels 101 which are placed in an end-to-end fashion relative to each other in an office or other commercial or home office setting. Each wall panel 101 generally includes elongate distribution arrangement 103 in the form a raceway 103 that is an elongate hollow opening extending across the width of panel 101 at a convenient location, which line up with each other in an end-to-end manner from panel 101 to panel 101. For example, as indicated, raceways 103 could be formed as a number of beltline raceways which line up with each other in an end-to-end manner from panel to panel, or could be raceways 103 formed at or near the bottom of panels 101 which line up with each other in an end-to-end manner from panel to panel. As another example, as indicated, the office furniture 1101 could be a desk or a table, and the elongate distribution arrangement 1103 could be a distribution channel formed in the desk or table. As yet another example, the elongate distribution arrangement 1103 could be in the form of an elongate channel with a generally U-shaped cross section which is attached to the bottom of the desk or table. Thus, each said elongate distribution arrangement 1103 can, for example and not limitation, include: a beltline raceway in an office wall panel; a bottom raceway 103 in an office wall panel 101; a distribution channel formed in a desk or table; or a distribution channel attached to the bottom of a desk or table.

FIG. 1 thus shows panel system 100, which can, according to an exemplary embodiment of the present invention, be a modular wall panel system used in an office space to partition an open floor plan environment by way of partitioning walls. Panel system 100 includes wall panel 101 (for example, a modular wall panel used as such a partitioning wall) and an electrical distribution system 102 associated with or coupled in any suitable manner with wall panel 101. Wall panel 101 includes a raceway 103, electrical distribution system 102 being coupled with raceway 103. Wall panel 101 can be a wall of any height and/or distance from the ceiling; for example, wall panel 101 may extend from floor to ceiling, or at any intermediate height therebetween. Further, depending upon the height of wall panel 101, raceway 103 may be positioned at any height within wall panel, for example, at the bottom of wall panel 101 (as in FIG. 1), at the top of wall panel 101, or at a beltline of wall panel 101. Further, wall panel 101 may alternatively be positioned at any select height above the floor and at any select distance from the ceiling.

Electrical distribution system 102 can be at least partially positioned within raceway 103 and can include electrical power distribution elements and/or data distribution elements. Electrical distribution system 102, in FIG. 1, is shown to include two electrical receptacles 104-L, 104-R (shown schematically connected to one another mechanically and electrically) and a jumper assembly (not shown and which can also be referred to as a jumper or a jumper device) which can be coupled with either of receptacles 104-L, 104-R and placed in and associated with or otherwise coupled with raceway 103. Here, receptacles 104-L, 104-R can be entirely positioned within raceway 103, or can be partially enclosed within raceway 103, and can partially extend outside of raceway 103. Receptacles 104-L, 104-R are associated with or otherwise coupled with and at least partially enclosed within raceway 103. Receptacles 104-L, 104-R are electrical modules, and the jumper assembly is also an electrical module. Electrical distribution system 102 can be any suitable system; by way of example and not limitation, electrical distribution system 102 can be a two circuit, four wire system.

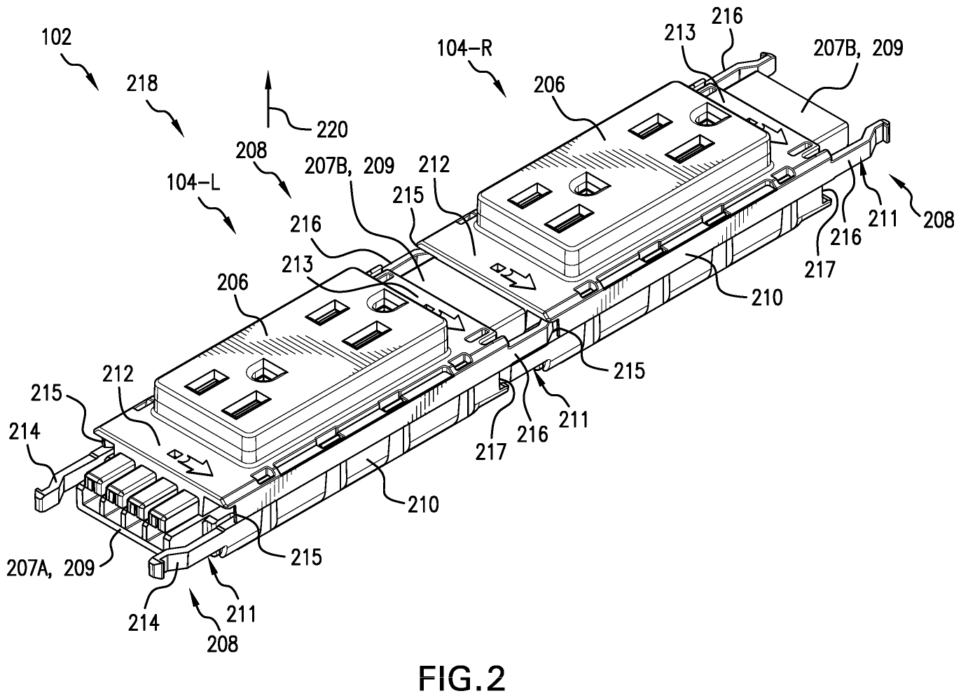

Referring now to FIG. 2, there is shown a perspective view of an embodiment of electrical distribution system 102, showing receptacles 104-L, 104-R mechanically and electrically connected together. Proceeding from left to right in FIG. 2, receptacle 104-L is the left receptacle, and receptacle 104-R is the right receptacle. Receptacles 104-L, 104-R are substantially identical to one another. Receptacles 104-L, 104-R each includes an outlet face 206, to which a three-pronged electrical plug can be directly connected. Here, outlet faces 206 of receptacles 104-L, 104-R are shown to point in the same direction. However, alternatively, receptacles 104-L, 104-R can be directly connected to one another in such a way that outlet faces 206 point in opposite directions relative to one another (which is explained further below). Each receptacle 104-L, 104-R includes a connection arrangement 208, which includes a latching arrangement 211 and an electrical connection arrangement 209, that includes electrical connectors 207A, 207B at opposing ends of respective receptacles 104-L, 104-R. Respective electrical connectors 207A, 207B of receptacles 104-L, 104-R are shown in FIG. 2 to be connected directly to one another. Electrical connectors 207A, 207B are hermaphroditic and substantially identical to one another, and thus electrical connectors 207A, 207B can directly connect with other electrical connectors 207A, 207B (explained further below).

Further, each receptacle 104-L, 104-R includes a body 210, a first end 212, a second end 213 opposing first end 212, and latching arrangement 211. Body 210 at least partly includes electrical connectors 207A, 207B, each of which includes ports 327, 328 defined by body 210 and respective ends of electrical terminals 532, 533, 534, 535 housed within body 210. First end 212 includes electrical connector 207A, and second end 213 includes electrical connector 207B. Latching arrangement 211 of receptacle 104-L, 104-R includes a first pair of male latch members 214, a first pair of female latch members 215, a second pair of male latch members 216, a second pair of female latch members 217, first end 212 including the first pair of male latch members 214 and the first pair of female latch members 215, second end 213 including the second pair of male latch members 216 and the second pair of female latch members 217. According to an embodiment of the present invention, male latch members 214, 216 are substantially similar to one another, and female latch members 215, 217 are substantially similar to one another. Body 210 of each receptacle 104-L, 104-R defines female latch members 215, 217. Latching arrangement 211 is configured for releasably securing receptacles 104-L, 104-R with one another. As shown in FIG. 2, the second pair of female latch members 217 of second end 213 of receptacle 104-L and the second pair of male latch members 216 of second end 213 of receptacle 104-L are selectively and releasably coupled with the first pair of male latch members 214 of first end 212 of receptacle 104-R and the first pair of female latch members 215 of first end 212 of receptacle 104-R respectively. Female latch members 215, 217 receive male latch members 214, 216 and releasably latch thereto (as explained further below).

Electrical connection arrangement 209 of each of receptacles 104-L, 104-R is, and thus electrical connectors 207A, 207B are, hermaphroditic. As a result, electrical connector 207A of an electrical receptacle (i.e., receptacle 104-L) can be selectively connected with either of electrical connector 207A and 207B of another electrical receptacle (i.e., receptacle 104-R), and, similarly, electrical connector 207B of an electrical receptacle (i.e., receptacle 104-L) can be selectively connected with either of electrical connector 207A and 207B of another electrical receptacle (i.e., receptacle 104-R).

Further, though not shown, according to an alternative embodiment of the present invention, body 210 of receptacles 104-L, 104-R can include screw tabs on longitudinally extending sides of receptacles 104-L, 104-R. Fasteners, such as screws, can be inserted through holes in such screw tabs so as to secure (directly or indirectly) receptacles 104-L, 104-R to a respective wall panel 101, for example.

Further, receptacles 104-L, 104-R are selectively and releasably connected directly to one another (by way of connection arrangement 208, including electrical connection arrangement 209 and latching mechanism 211) in one of two orientations 218, 819 and are configured for being selectively and releasably connected directly to one another in the other of the two orientations 218, 819 (which can also be referred to as first orientation 218 and second orientation 819). That is, user is able to connect receptacles 104-L in orientation 218 or, alternatively in orientation 219, according to the needs of the installation situation. In this way, an electrical distribution harness is not required to electrify receptacles 104-L, 104-R and to mount electrical receptacles 104-L, 104-R in or otherwise to raceway 103; instead, electrical receptacles 104-L, 104-R can be mounted directly to one another, in either of two orientations 218, 819. FIG. 2 shows electrical receptacles 104-L, 104-R in orientation 218. Thus, when receptacles 104-L, 104-R are in orientation 218 (as shown in FIG. 2), outlet face 206 of receptacle 104-L and outlet face 206 of receptacle 104-R each face in the same direction, that is, in first direction 220, and electrical connector 207B of receptacle 104-L is connected directly to electrical connector 207A of receptacle 104-R.

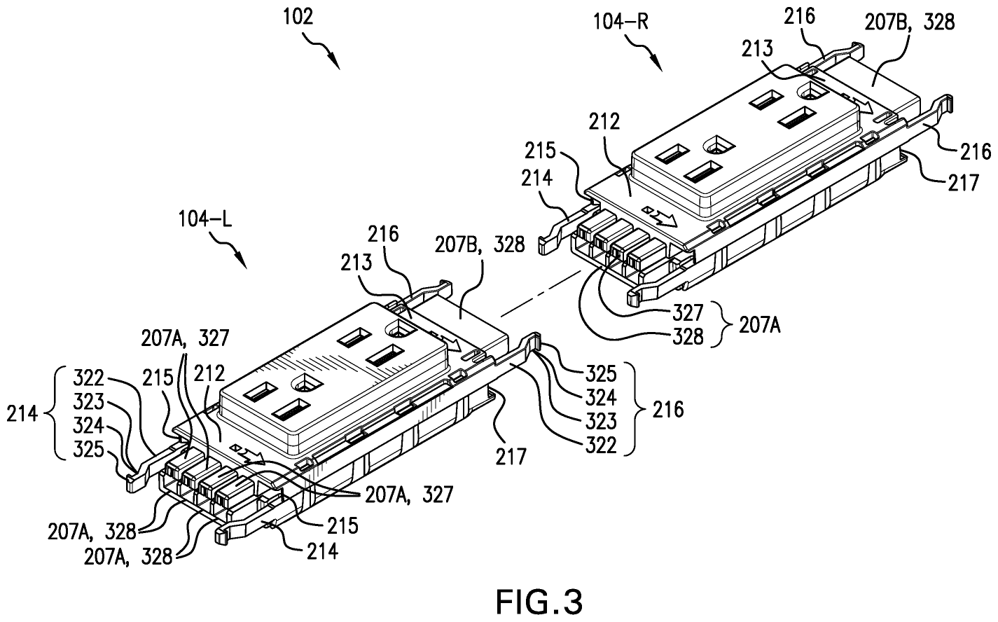

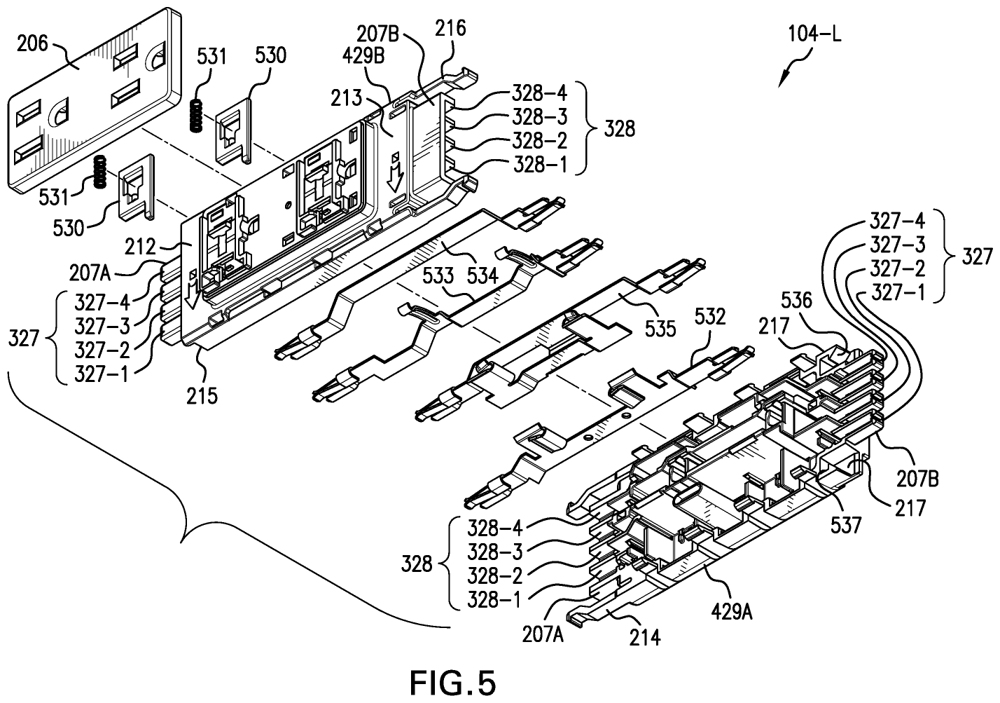

Referring now to FIG. 3, there is shown an exploded perspective view of electrical distribution system 102 shown in FIG. 2. Each electrical connector 207A, 207B includes male ports 327 and female ports 328. Male ports 327 accommodate or otherwise include therein female portions of electrical terminals 532, 533, 534, 535, and female ports 328 include therein male portions of electrical terminals 532, 533, 534, 535 (see FIG. 5). Female ports 328 of either of electrical connectors 207A, 207B matingly receive therein male ports 327 of the other of electrical connectors 207A, 207B. Further, each male latch member 214, 216 of receptacles 104-L, 104-R includes a proximal portion 322 and a distal portion 323, proximal portion 322 extending from body 210 as a cantilevered beam 322, distal portion 323 extending from proximal portion 322 as a hook 324, which includes a barb 325.

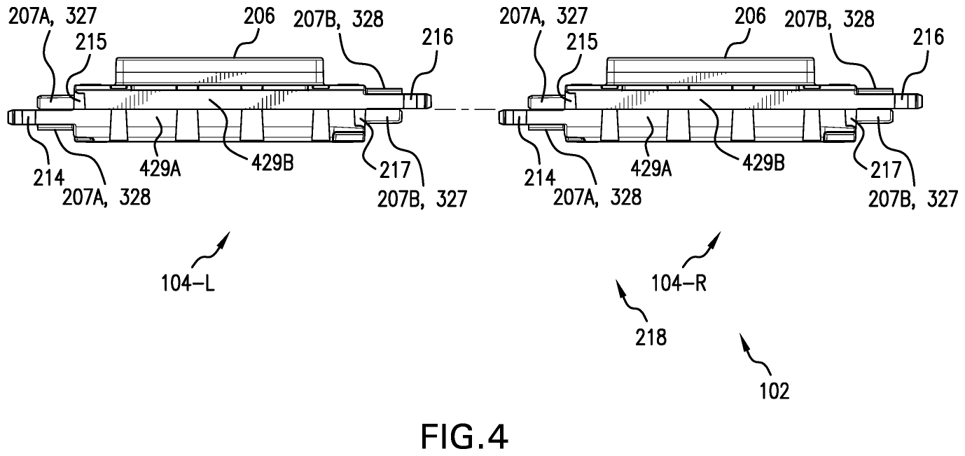

Referring now to FIG. 4, there is shown an exploded side view of electrical distribution system 102. More specifically, FIG. 4 shows receptacle 104-L and receptacle 104-R detached from one another. Regarding receptacles 104-L, 104-R, on first end 212 the pair of female latch members 215 are vertically displaced relative to the pair of male latch members 214 such that the pair of female latch members 215 are positioned above the pair of male latch members 214, and on second end 213 the pair of female latch members 217 are vertically displaced relative to the pair of male latch members 216 such that the pair of female latch members 217 are positioned vertically below the pair of male latch members 216. Further, according to an exemplary embodiment of receptacle 104-R (and thus also receptacle 104-L), body 210 includes two halves 429A, 429B (which can also be referred to as a base 429A and a cover 429B), which can be joined together in any suitable manner, such as (for example and not limitation) by way of a snap fit and/or fasteners (such as rivets).

According to an embodiment of the present invention, body halves 429A, 429B (as well as outlet faces 206 and shutters 530 (below)) can be made of any suitable material, such as (for example and not by way of limitation) a metal and/or a polymer, and can be formed in any suitable manner, such as (for example and not by way of limitation) a molding operation, such as injection molding. Thus, according to an embodiment of the present invention, ports 327, 328 and latch members 214, 215, 216, 217 can be formed integral—as part of an injection molding operation—with their respective body halves 429A, 429B.

Referring now to FIG. 5, there is shown an exploded perspective view of an electrical receptacle, namely, receptacle 104-L. Shown are body halves 429A, 429B, outlet face 206 which attaches to or is formed as a part of body half 429B, shutters 530 which couple with body half 429B, compression springs 531 which couple with body half 429B, and electrical terminals 532, 533, 534, 535 which position within body halves 429A, 429B and are made of any suitable electrically conductive material. Terminal 532 is a neutral terminal, terminal 533 is a ground terminal, terminal 534 is line terminal (pass-through), and terminal 535 is line terminal. Body half 429A is shown to include part of electrical connector 207A including female ports 328-1, 328-2, 328-3, 328-4 and part of electrical connector 207B including male ports 327-1, 327-2, 327-3, 327-4. Similarly, body half 429B is shown to include part of electrical connector 207A including female ports 328-1, 328-2, 328-3, 328-4 and part of electrical connector 207B including male ports 327-1, 327-2, 327-3, 327-4. Terminal 532 includes opposing longitudinal ends that are positioned respectively in male ports 327-1 and female ports 328-1 of housing halves 429A, 429B; more specifically, each opposing longitudinal end of terminal 532 includes a male portion and a female portion, the male portion being positioned in female ports 328-1 of housing halves 429A, 429B, the female portion being positioned in male ports 327-1 of housing halves 429A, 429B. Terminal 533 includes opposing longitudinal ends that are positioned respectively in male ports 327-2 and female ports 328-2 of housing halves 429A, 429B; more specifically, each opposing longitudinal end of terminal 533 includes a male portion and a female portion, the male portion being positioned in female ports 328-2 of housing halves 429A, 429B, the female portion being positioned in male ports 327-2 of housing halves 429A, 429B. Terminal 534 includes opposing longitudinal ends that are positioned respectively in male ports 327-3 and female ports 328-3 of housing halves 429A, 429B; more specifically, each opposing longitudinal end of terminal 534 includes a male portion and a female portion, the male portion being positioned in female ports 328-3 of housing halves 429A, 429B, the female portion being positioned in male ports 327-3 of housing halves 429A, 429B. Terminal 535 includes opposing longitudinal ends that are positioned respectively in male ports 327-4 and female ports 328-4 of housing halves 429A, 429B; more specifically, each opposing longitudinal end of terminal 535 includes a male portion and a female portion, the male portion being positioned in female ports 328-4 of housing halves 429A, 429B, the female portion being positioned in male ports 327-4 of housing halves 429A, 429B. During connection of electrical connectors 207A, 207B of receptacles 104-L, 104-R, male ports 327 are received by female ports 328, and female portions of terminals 532, 533, 534, 535 receive male portions of terminals 532, 533, 534, 535.

Further, each female latch member 215, 217 of receptacle 104-L (and thus also receptacle 104-R) includes an inwardly projecting ramp 536 and a recess 537. Each ramp 536 is configured for being abutted against by a respective distal portion 323 respectively as male latch members 214, 216 are respectively inserted in female latch portions 215, 217. As this abutment occurs, male latch members 214, 216 (which are resilient) are deflected inwardly as distal portions 323 slide along ramps 536. Each recess 537 is configured for receiving and holding therein a respective barb 325 after a respective distal portion 323 of respective male latch members 214, 216 slide over a respective ramp 536 when respective male latch members 214, 216 are inserted in respective female latch members 215, 217.

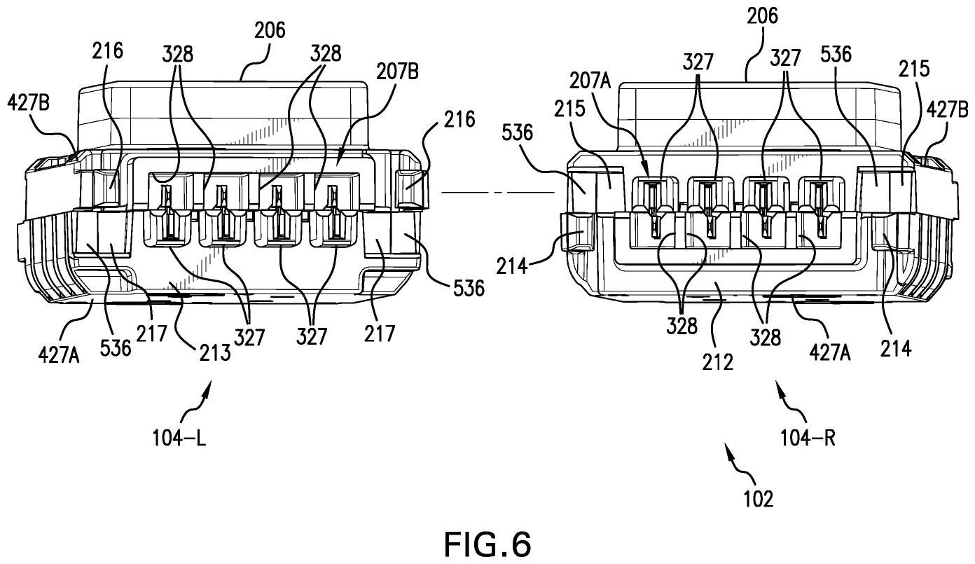

Referring now to FIG. 6, there is shown a perspective view of receptacles 104-L, 104-R, with mating ends of receptacles 104-L, 104-R turned in toward one another. Thus, in the foreground of FIG. 6 are end 213 of receptacle 104-L and end 212 of receptacle 104-R. Shown in FIG. 6 are also male latch members 214, 216, female latch members 215, 217, and male ports 327 and female ports 328 of electrical connectors 207A, 207B.

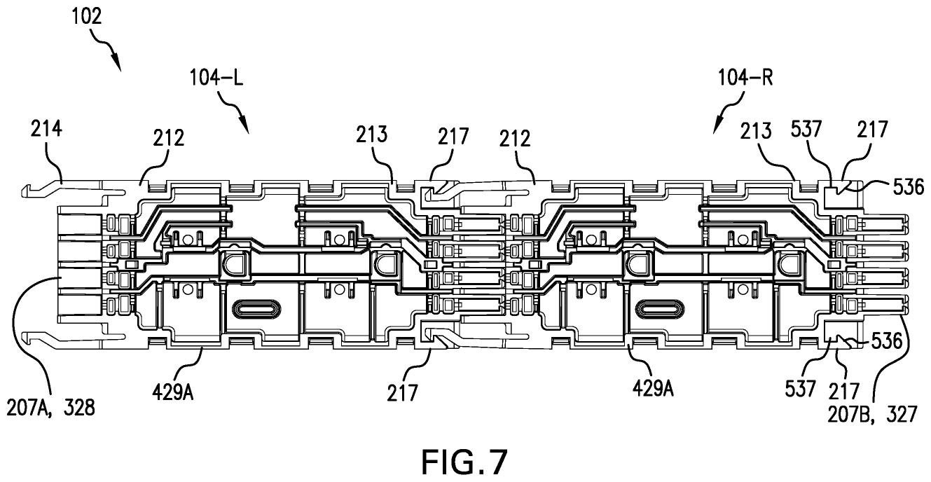

Referring now to FIG. 7, there is shown interior side views of receptacles 104-L, 104-R, with portions broken away (such as terminals 532, 533, 534, 535). Body half 429A of each of receptacles 104-L, 104-R is shown. Body halves 429A of receptacles 104-L, 104-R are shown connected together by way of portions of electrical connectors 207A, 207B and latching mechanisms 211. With respect to end 213 of receptacle 104-L and end 212 of receptacle 104-R, male ports 327 are received by female ports 328, and barbs 325 of male latch members 216 are seated respectively in recesses 537 of female latch members 217. This seating occurs after barbs 325 of male latch members 216 of receptacle 104-R slide along ramps 536 of female latch members 217 of receptacle 104-L (which causes male latch members 216 to deflect inwardly toward one another), male latch members 216 snapping into place in a respective recesses 537 after traversing ramps 536. Male latch members 216 can be released from recesses 537 when a user depresses male latch members 216 inwardly toward one another (such as by way of a thumb and forefinger of user) so as to clear recesses 536, and then user can pull receptacle 104-L and 104-R away from one another to complete the disengagement of receptacle 104-L and 104-R relative to one another. The illustrated connection in FIG. 7 (i) between electrical connectors 207B of second end 213 of receptacle 104-L and electrical connector 207A of first end 212 of receptacle 104-R and (ii) between male latch members 216 of receptacle 104-R and female latch members 217 of receptacle 104-L using latching arrangement 211 is substantially similar to any and all connections that can be made between receptacles 104-R, 104-L at their respective ends 212, 213 according to the present invention and thus represents any such connection according to the present invention.

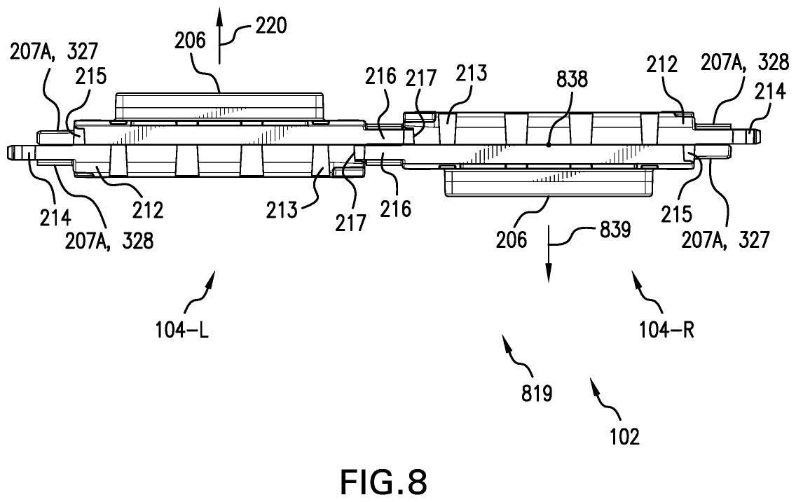

Referring now to FIG. 8, there is shown a side view of electrical distribution system 102 in orientation 819. More specifically, FIG. 8 shows receptacle 104-L and receptacle 104-R connected to one another in orientation 819. In orientation 819, second end 213 of receptacle 104-L and second end 213 of receptacle 104-R are adjacent to one another, and thus electrical connector 207B of second end 213 of receptacle 104-L is connected to electrical connector 207B of second end 213 of receptacle 104-R, male latch member 216 of second end 213 of receptacle 104-L is connected with female latch member 217 of second end 213 of receptacle 104-R, and male latch member 216 of second end 213 of receptacle 104-R is connected with female latch member 217 of second end 213 of receptacle 104-L. Thus, when receptacles 104-L, 104-R are in orientation 819 relative to one another, outlet face 206 of receptacle 104-L faces in first direction 220, and outlet face 206 of receptacle 104-R faces in a second direction 839 which is opposite first direction 220, and electrical connector 207B of receptacle 104-L is connected directly to electrical connector 207B of receptacle 104-R. To move receptacle 104-R from first orientation 218 to second orientation 819, receptacle 109-R is pivoted 180 degrees about an axis 838 extending perpendicular to the page of FIG. 8 and thus substantially perpendicularly through each longitudinal side of receptacle 104-R.

In use, electrical distribution system 102 can be coupled with one or more wall panels 101 to form electrical wall panel system 100. Receptacles 104-L, 104-R can be accommodated at least substantially within a thin wall panel 101, such as a one-inch thick wall panel, such that raceway 103 is also one-inch thick. Further, receptacles 104-L, 104-R can be selectively connected to one another in either of first orientation 218 (where outlet faces 206 of receptacles 104-L, 104-R face in the same direction relative to one another) or second orientation 819 (where outlet faces 206 of receptacles 104-L, 104-R face in opposite directions relative to one another). To make these connections, pertinent electrical connectors 207A, 207B and male and female latch members 214, 215, 216, 217 are connected to one another. To connect male and female latch members 214, 215, 216, 217 together, pertinent male latch members 214, 216 are squeezed toward one another. To detach receptacles 104-L, 104-R from one another, pertinent male latch members 214, 216 are squeezed toward one another to unseat barbs 325 from recesses 537, and then receptacles 104-L, 104-R are pulled apart.

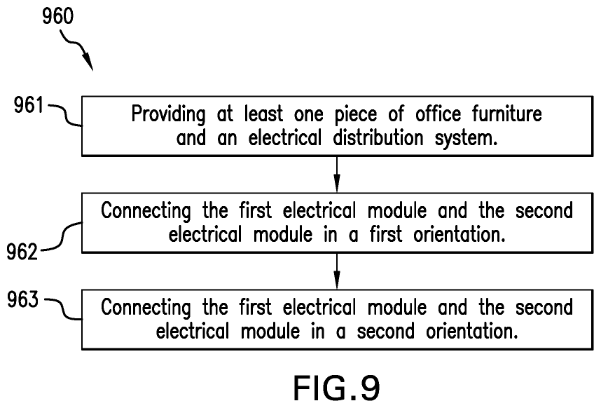

Referring now to FIG. 9, there is shown a flow diagram showing a method 960 of using electrified wall panel system 101, in accordance with an exemplary embodiment of the present invention. Method 960 includes the steps of: providing 961 that electrified office furniture system 100 includes at least one piece of office furniture 1101, 101 and electrical distribution system 102 which is associated with at least one piece of office furniture 1101, 101; connecting 962, selectively and releasably, first electrical module 104-L of electrical distribution system 102 and second electrical module 104-R of electrical distribution system 102 directly to one another in one of two orientations 218, 819; and connecting 963, selectively and releasably, first electrical module 104-L and second electrical module 104-R directly to one another in the other of the two orientations 218, 819. Each of first electrical module 104-L and second electrical module 104-R includes first end 212 including first electrical connector 207A, second end 213 opposing first end 212 and including second electrical connector 207B, and outlet face 206, wherein the two orientations 218, 819 includes first orientation 218 and second orientation 819, wherein, when first electrical module 104-L and second electrical module 104-R are in first orientation 218 relative to one another, outlet face 206 of first electrical module 104-L and outlet face 206 of second electrical module 104-R each face in first direction 220. When first electrical module 104-L and second electrical module 104-R are in first orientation 218 relative to one another, second electrical connector 207B of first electrical module 104-L is connected directly to first electrical connector 207A of second electrical module 104-R. When first electrical module 104-L and second electrical module 104-R are in second orientation 819 relative to one another, outlet face 206 of first electrical module 104-L faces in first direction 220, and outlet face 206 of second electrical module 104-R faces in second direction 839 which opposes first direction 220. When first electrical module 104-L and second electrical module 104-R are in second orientation 839 relative to one another, second electrical connector 207B of first electrical module 104-L is connected directly to second electrical connector 207B of second electrical module 104-R. First electrical module 104-L and second electrical module 104-R each includes an electrical connection arrangement 209 that is hermaphroditic. The at least one piece of office furniture 1101, 101 includes an elongate distribution arrangement 1103, 103, the electrical distribution system 102 being associated with the elongate distribution arrangement 1103, 103, the first electrical module 104-L and the second electrical module 104-R each being positioned within the elongate distribution arrangement 1103, 103, each said elongate distribution arrangement 1103, 103 including: a beltline raceway 1103 in an office wall panel 1101; a bottom raceway 103 in an office wall panel 101; a distribution channel 1103 formed in a desk 1101 or table 1101; and a distribution channel 1103 attached to the bottom of a desk 1101 or table 1101.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An electrified office furniture system, comprising:
at least one piece of office furniture; and
an electrical distribution system associated with the at least one piece of office furniture, the electrical distribution system including:
a first electrical module; and
a second electrical module, the first electrical module and the second electrical module being selectively and releasably connected directly to one another in one of two orientations, and being configured for being selectively and releasably connected directly to one another in the other of the two orientations.

2. The electrified office furniture system according to claim 1, wherein each of the first electrical module and the second electrical module includes a first end including a first electrical connector, a second end opposing the first end and including a second electrical connector, and an outlet face,
wherein the two orientations includes a first orientation and a second orientation,
wherein, when the first electrical module and the second electrical module are in the first orientation relative to one another, the outlet face of the first electrical module and the outlet face of the second electrical module each face in a first direction.

3. The electrified office furniture system according to claim 2, wherein, when the first electrical module and the second electrical module are in the first orientation relative to one another, the second electrical connector of the first electrical module is connected directly to the first electrical connector of the second electrical module.

4. The electrified office furniture system according to claim 3, wherein when the first electrical module and the second electrical module are in the second orientation relative to one another, the outlet face of the first electrical module faces in the first direction, and the outlet face of the second electrical module faces in a second direction which opposes the first direction.

5. The electrified office furniture system according to claim 4, wherein, when the first electrical module and the second electrical module are in the second orientation relative to one another, the second electrical connector of the first electrical module is connected directly to the second electrical connector of the second electrical module.

6. The electrified office furniture system according to claim 5, wherein the first electrical module and the second electrical module each includes an electrical connection arrangement that is hermaphroditic.

7. The electrified office furniture system of claim 1, wherein the at least one piece of office furniture includes an elongate distribution arrangement, the electrical distribution system being associated with the elongate distribution arrangement, the first electrical module and the second electrical module each being positioned within the elongate distribution arrangement, each said elongate distribution arrangement comprising one of:
a beltline raceway in an office wall panel;
a bottom raceway in an office wall panel;
a distribution channel formed in a desk or table; and
a distribution channel attached to the bottom of a desk or table.

8. An electrical distribution system for an electrified office furniture system, the electrified office furniture system including at least one piece of office furniture, the electrical distribution system being associated with the at least one piece of office furniture, the electrical distribution system comprising:
a first electrical module which is configured for being selectively and releasably connected directly with a second electrical module in one of two orientations and for being selectively and releasably connected directly with the second electrical module in the other of the two orientations.

9. The electrical distribution system according to claim 8, wherein the electrical distribution system includes the second electrical module, the first electrical module and the second electrical module being selectively and releasably connected directly to one another in one of the two orientations and being configured for being selectively and releasably connected directly to one another in the other of the two orientations,
wherein each of the first electrical module and the second electrical module includes a first end including a first electrical connector, a second end opposing the first end and including a second electrical connector, and an outlet face,
wherein the two orientations includes a first orientation and a second orientation,
wherein, when the first electrical module and the second electrical module are in the first orientation relative to one another, the outlet face of the first electrical module and the outlet face of the second electrical module each face in a first direction.

10. The electrical distribution system according to claim 9, wherein, when the first electrical module and the second electrical module are in the first orientation relative to one another, the second electrical connector of the first electrical module is connected directly to the first electrical connector of the second electrical module.

11. The electrical distribution system according to claim 10, wherein when the first electrical module and the second electrical module are in the second orientation relative to one another, the outlet face of the first electrical module faces in the first direction, and the outlet face of the second electrical module faces in a second direction which opposes the first direction.

12. The electrical distribution system according to claim 11, wherein, when the first electrical module and the second electrical module are in the second orientation relative to one another, the second electrical connector of the first electrical module is connected directly to the second electrical connector of the second electrical module.

13. The electrical distribution system according to claim 12, wherein the first electrical module and the second electrical module each includes an electrical connection arrangement that is hermaphroditic.

14. A method of using an electrified office furniture system, the method comprising the steps of:
providing that the electrified office furniture system includes an at least one piece of office furniture and an electrical distribution system which is associated with the at least one piece of office furniture;
connecting, selectively and releasably, a first electrical module of the electrical distribution system and a second electrical module of the electrical distribution system directly to one another in one of two orientations; and
connecting, selectively and releasably, the first electrical module and the second electrical module directly to one another in the other of the two orientations.

15. The method according to claim 14, wherein each of the first electrical module and the second electrical module includes a first end including a first electrical connector, a second end opposing the first end and including a second electrical connector, and an outlet face,
wherein the two orientations includes a first orientation and a second orientation,
wherein, when the first electrical module and the second electrical module are in the first orientation relative to one another, the outlet face of the first electrical module and the outlet face of the second electrical module each face in a first direction.

16. The method according to claim 15, wherein, when the first electrical module and the second electrical module are in the first orientation relative to one another, the second electrical connector of the first electrical module is connected directly to the first electrical connector of the second electrical module.

17. The method according to claim 16, wherein when the first electrical module and the second electrical module are in the second orientation relative to one another, the outlet face of the first electrical module faces in the first direction, and the outlet face of the second electrical module faces in a second direction which opposes the first direction.

18. The method according to claim 17, wherein, when the first electrical module and the second electrical module are in the second orientation relative to one another, the second electrical connector of the first electrical module is connected directly to the second electrical connector of the second electrical module.

19. The method according to claim 18, wherein the first electrical module and the second electrical module each includes an electrical connection arrangement that is hermaphroditic.

20. The method of claim 14, wherein the at least one piece of office furniture includes an elongate distribution arrangement, the electrical distribution system being associated with the elongate distribution arrangement, the first electrical module and the second electrical module each being positioned within the elongate distribution arrangement, each said elongate distribution arrangement comprising one of:
a beltline raceway in an office wall panel;
a bottom raceway in an office wall panel;
a distribution channel formed in a desk or table; and
a distribution channel attached to the bottom of a desk or table.
